(19) United States
(12) Patent Application Publication
(10) Pub. No.: US 2013/0321601 A1
(43) Pub. Date: Dec. 5, 2013

(54) OBSERVATION INSTRUMENT

(71) Applicant: KUO-FONG TSENG, Tu-Cheng (TW)

(72) Inventor: KUO-FONG TSENG, Tu-Cheng (TW)

(21) Appl. No.: 13/661,841

(22) Filed: Oct. 26, 2012

(30) Foreign Application Priority Data
May 30, 2012 (TW) 101119393

(51) Int. Cl. H04N 5/225

(52) U.S. Cl. 348/65; 348/333.08; 348/E05.024

(57) ABSTRACT

An observation instrument includes an image capturing device, a processor, a first display, a second display, a half mirror and a pair of polarized glasses. The processor is electrically connected to the image capturing device. The first display and the second display are electrically connected to the processor. The first display and the second display face each other, and cooperatively define a right or an obtuse angle. The half mirror is located on an angle bisector line defined by the first and the second displays for receiving emitting lights. The polarized glasses is located at a front of the half mirror, and comprises a first lens and a second lens, in which the first lens allows a perpendicularly polarized light to pass through only, the second lens allows a horizontally polarized light to pass through only.

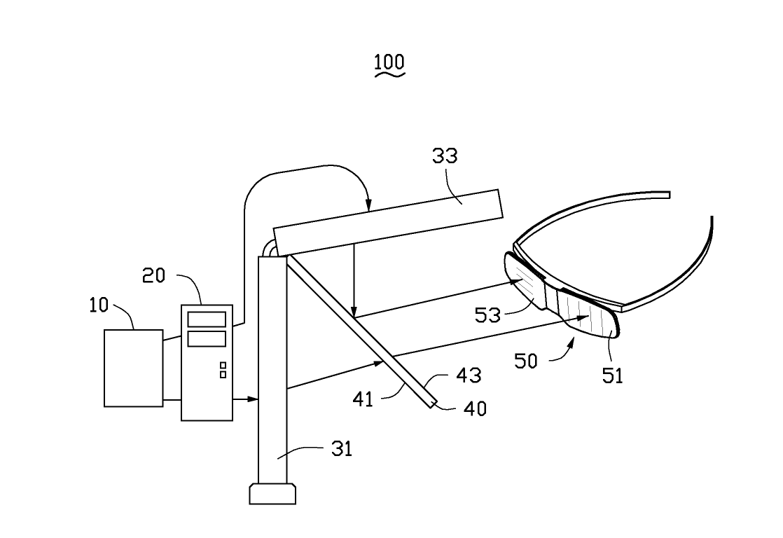

### BACKGROUND

1. Technical Field

The present disclosure relates to an observation instrument, and more particularly, to an observation instrument with a polarized glass.

2. Description of Related Art

Observation instrument is used to observe human viscera in the medical field. The observation instrument may be a computed tomography device, such that an abnormal or malignant tissue/tumor in the size of 5 millimeters may be detected. However, the computed tomography device is complicated, such that the cost is relatively high.

Therefore, there is room for improvement in the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

The FIGURE is a schematic view of an embodiment of an observation instrument.

### DETAILED DESCRIPTION

The FIGURE shows an observation instrument 100 for observing human viscera. The observation instrument 100 includes a image capturing device 10, a processor 20, a first display 31, a second display 33, a half mirror 40 and a pair of polarized glasses 50. The image capturing device 10 is electrically connected to the processor 20 for transferring picture signals to the processor 20. The first display 31 and the second display 33 are electrically connected to the processor 20 for receiving picture signals from the processor 20. The first display 31 and the second display 33 cooperatively define an angle therebetween. The half mirror 40 is located between the first display 31 and the second display 33 for receiving light beams therefrom. The pair of polarized glasses 50 is located at front of the half mirror 40 to observe an image displayed on the half mirror 40.

The image capturing device 10 is capable of capturing the image signals of the human viscera. The processor 20 is capable of receiving image signals from the image capturing device 10. In the embodiment, the image capturing device 10 is an endoscope, and the processor 20 is a computer.

The first display 31 and the second display 33 are electrically connected to the processor 20, respectively, for receiving the picture or image signals. The first display 31 and the second display 33 receive the same picture or image signals from the processor 20 and then display the pictures or images. The first display 31 and the second display 33 face each other. A first end of the first display 31 abuts against a first end of the second display 33, a second end of the first display 31 opposite to the first end thereof is away from a second end of the second display 33 opposite to the first end of the second display 33, such that an angle is defined between the two displays 31, 32. The angle can be a right angle or an obtuse angle. In the embodiment, the first display 31 is the same type of display as the second display 33 and both are liquid crystal displays.

The half mirror 40 is located between the first display 31 and the second display 33. An end of the half mirror 40 is connected to the abutting ends between the first display 31 and the second display 33, the other end of the half mirror 40 extends along an angle bisector line defined by the first display 31 and the second display 33. The half mirror 40 has a shape the same as that of the first display 31. The half mirror 40 includes a first surface 41 and a second surface 43 opposite to the first surface 41. The first surface 41 faces the first display 31, and the second surface 43 faces the second display 33.

The pair of polarized glasses 50 includes a first lens 51 corresponding to the left eye and a second lens 53 corresponding to the right eye. The first lens 51 only allows a perpendicularly polarized light to pass therethrough. Meanwhile, the second lens 53 only allows a horizontally polarized light passing therethrough.

When the polarized glasses 50 is located at the front of the second surface 43 of the half mirror 40. Images in the form of light emitting from the first display 31 enters the half mirror 40 via the first surface 41, and emits out of the second surface 43. In the imaging process, a polarizing axis of the emitting light is rotated about 90 degrees, and the emitting light which was in a horizontally polarized state/wave is rotated into a perpendicularly polarized state/wave. The emitting light from the first display 31 is rotated into the perpendicular polarized state/wave via the half mirror 40 and enters into the first lens 51 of the polarized glasses 50. Emitting light from the second display 33 is reflected by the second surface 43, and the emitting light from the second display 33 is maintained in the horizontal polarized state when being reflected by the second surface 43. The emitting light from the second display 33 is maintained in the horizontally polarized state and enters into the second lens 53, thus a three dimensional picture or image can be observed by using the polarized glasses 50.

On the contrary, when the polarized glasses 50 is located in front of the first surface 41, the emitting light from the second display 33 is rotated into the perpendicularly polarized state via the half mirror 40 and enters into the first lens 51 of the polarized glasses 50. The emitting light from the first display 31 is maintained in the horizontal polarized state and enters into the second lens 53, and thus a three dimensional picture or image can be observed by using the polarized glasses 50 when located in front of the first surface 41.

When in use of the observation instrument, electrical power is applied to the image capturing device 10 and the processor 20. The image capturing device 10 is inserted to be located in a human's stomach to capture and transmit one or more picture or image signals. The operator puts on the polarized glasses 50 and observes the images seen on the first surface 41 or the second surface 43 of the half mirror 40.

The image capturing device 10 may be other machines, such as a X-ray machine. The processor 20 may be other processors, such as a micro-chip processor. The first display 31 and the second display 33 may be of other type of display panels, such as an LED displaying panel. The first lens 51 may be configured to be corresponding to the right eye, and the second lens 53 is configured to be corresponding to the left eye.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. An observation instrument, comprising:
an image capturing device;
a processor electrically connected to the image capturing device;
a first display electrically connected to the processor;
a second display electrically connected to the processor, wherein the first display and the second display are configured to be facing each other and cooperatively defining a right angle or an obtuse angle therebetween;
a half mirror located on an angle bisector line defined by the first display and the second display, and receiving emitting lights therefrom; and
a pair of polarized glasses located at a front of the half mirror, and comprising a first lens and a second lens, wherein the first lens allows a perpendicularly polarized light to pass through only, the second lens allows a horizontally polarized light to pass through only.

2. The observation instrument of claim 1, wherein a first end of the first display abuts against a first end of the second display, a second end of the first display opposite to the first end thereof is away from a second end of the second display opposite to the first end of the second display.

3. The observation instrument of claim 1, wherein the first display is a liquid crystal display, and the second display is a liquid crystal display.

4. The observation instrument of claim 1, wherein an end of half mirror is connected to the abutting ends of the first display and the second display, the other end of the half mirror extends along an angle bisector line defined by the first display and the second display, the half mirror has a shape same as that of the first display.

5. The observation instrument of claim 4, wherein the half mirror comprises a first surface and a second surface opposite to the first surface, the first surface facing the first display, the second surface facing the second display.

6. The observation instrument of claim 5, wherein the pair of polarized glasses is located at a front of the first surface or the second surface of the half mirror.

7. The observation instrument of claim 1, wherein the image capturing device is an endoscope or an X-ray machine.

8. An observation instrument, comprising:
an image capturing device;
a processor electrically connected to the image capturing device;
a first display and a second display respectively electrically connected to the processor, wherein the first display and the second display face each other and cooperatively defines an angle therebetween;
a half mirror located between the first and the second displays for receiving emitting lights from the first and the second displays, respectively , wherein an end of the half mirror is connected to the abutting end portion between the first display and the second display, the other end of the half mirror extends along an angle bisector line defined by the first display and the second display; and
a pair of polarized glasses located at a front of the half mirror, and comprising a first lens and a second lens, wherein the first lens allows a perpendicularly polarized light to pass through only, the second lens allows a horizontally polarized light to pass through only.

9. The observation instrument of claim 8, wherein a first end of the first display abuts against a first end of the second display, a second end of the first display opposite to the first end of the first display is away from a second end of the second display opposite to the first end thereof, the angle defined therebetween is a right angle or an obtuse angle.

10. The observation instrument of claim 8, wherein the first display and the second display are a plurality of liquid crystal displays.

11. The observation instrument of claim 8, wherein the half mirror has a shape same as that of the first display for receiving emitting lights from the first and the second displays.

12. The observation instrument of claim 11, wherein the half mirror comprises a first surface and a second surface opposite to the first surface, the first surface faces the first display, the second surface faces the second display.

13. The observation instrument of claim 12, wherein the pair of polarized glasses is located at a front of the first surface or the second surface of the half mirror.

14. The observation instrument of claim 8, wherein the image capturing device is an endoscope or an X-ray machine.
